(19) United States
(12) Patent Application Publication
(10) Pub. No.: US 2012/0242013 A1
(43) Pub. Date: Sep. 27, 2012

(54) Shaping Device of PU Three-dimensional Objects and Its Shaping Method Thereof

(75) Inventor: Menq-Fong Shieh, Tainan (TW)

(73) Assignee: Foamtech Polymer Co., Ltd., Hui-zhou (CN)

(21) Appl. No.: 13/072,224

(22) Filed: Mar. 25, 2011

(51) Int. Cl. B29C 43/10

(52) U.S. Cl. 264/571; 425/112

(57) ABSTRACT

The invention relates to a shaping device of PU three-dimensional objects, including an external mold and an internal mold; the foresaid PU three-dimensional objects shaping device also includes a shell, wherein the outer wall of the foresaid shell installs with an evacuating valve; the foresaid external mold has air vent, and the size of the outer wall of the foresaid external mold is smaller than the size of the inner wall of the foresaid shell; the foresaid external mold installed insider the shell; the seams of the foresaid external mold and the edge of the shell is gas-tight sealed; the foresaid internal mold installed insider the foresaid external mold. When using the foresaid shaping device to work, we need to cover a layer of TPU film at the opening of the external mold, then start the evacuating equipment to extract the air between the installation gap of the shell and the external mold, in order to let the TPU film attach to the inner wall of the external mold, then we add the raw materials, and then install the internal mold to start the foaming process. By adopting the shaping device and its method, one foaming process could come out the finished products of PU three-dimensional objects, for which there is no need for the other working procedures, and it could obviously enhance the production rate, save the labor hour and decrease the production cost.

### TECHNICAL FIELD

The invention refers to a shaping device of Polyurethane (hereinafter refers as “PU”) three-dimensional objects and its shaping method thereof, more specifically refers to a shaping device applies to form the PU three-dimensional objects in one-shot molding and its shaping method thereof.

### BACKGROUND ART

With the development of the technology, the PU objects are commonly used among people's life because they are low-priced, convenient, easy to use and wildly applied, all sorts of the PU objects has already been producing in large scale, therefore it has becoming a major research subject for how to improve the manufacture technics, increase efficiency and enhance the automated production rate, so as to decrease the production cost.

Among the most widely applied technology to produce the PU three-dimensional objects is the foam shaping process technology, the operation method is: pour the PU raw materials into the molding, start heating and foaming after the mold is installed, then release the mold, after releasing the mold, a series of after treatment need to be done, such as polishing, trimming, cleaning, repairing, sanding, printing, waxing, sculpture, painting and other processes. Due to the requirement for after treatment according to the different needs after the foam shaping, various and tedious of manufacturing processes, the efficiency is very low, this production method has a relative higher production cost in total because the working time is longer.

### CONTENT OF THE INVENTION

The invention is to provide a shaping device of the PU three-dimensional objects and its shaping method thereof to come out of the finished products in one-shot molding without the needs for various processes for after treatments, by applying the shaping device and its method thereof could apparently increase the production rate of the PU three-dimensional objects, save labor time, reduce production cost, therefore increase the profit margin for the company.

For achieving the aims as above, the invention adopts the following technical solution: A shaping device of PU three-dimensional objects, including an external mold with at least one opening and an internal mold, characterized in that the foresaid PU three-dimensional objects shaping device also includes a shell, wherein the outer wall of the foresaid shell installed with an evacuating valve; the foresaid external mold has air vent, and the size of the outer wall of the foresaid external mold is smaller than the size of the inner wall of the foresaid shell; the foresaid external mold installed insider the shell; the seams of the foresaid external mold and the edge of the shell is gas-tight sealed; the foresaid internal mold installed insider the foresaid external mold.

In order to conveniently release the mold, the foresaid shell, external mold and internal mold are made by elastic materials. The shell, the internal mold are made by hard materials

The foresaid inner wall of the shell has at least two grooves.

The foresaid grooves of the inner wall of the shell interlaced with each other.

The foresaid grooves of the inner wall of the shell has groove in warp direction that is perpendicular to the bottom face of the shell and has groove in filling direction that is parallel to the bottom face of the shell.

The foresaid out wall of the external mold has air slot that is corresponding to the groove of the inner wall of the shell.

The air vent of the foresaid external mold is located at the foresaid air slot.

The foresaid out wall of the external mold has air slot that is corresponding to the groove of the inner wall of the shell; and the air vent of the foresaid external mold is located at the foresaid air slot.

The air vent of the foresaid external mold is located at the interlace place of the air slots.

The above setting of the inner wall of the shell, the out wall of the external mold and the air slot is able to let the air between the inner wall of the shell and the out wall of the external be drawn away evenly along the groove and air slot, so that the PU film is under the uniform pressure in the process, and is able to attach to the inner wall of the external mold evenly.

The foresaid shaping device of PU three-dimensional objects also includes thermal element, wherein the foresaid thermal element located in the upper end of the opening of the foresaid external mold.

A method of shaping PU three-dimensional objects according to the shaping device of PU three-dimensional objects including the following steps:

A. Install the mold in a proper location, open the evacuating valve in the shell, and connect the vacuum evacuating equipment with the evacuating valve of the shell;

B. Get out of the internal mold, and cover a ductile plastic film in the opening of the external mold;

C. Start the vacuum evacuating equipment to extract the air between the installation gap of the shell and the external mold, to let the Thermoplastic polyurethanes (hereinafter refers as “TPU”) film covered in the opening of the external mold extended and deformed and let the TPU film attach to the inner wall of the external mold;

D. Pour the PU raw materials;

E. Install the internal mold into the external mold and start the foaming process;

F. Close the evacuating valve in the out wall of the shell, and stop the vacuum evacuating equipment;

G. Release the mold.

In order to make the PU film extended and attached better in the above working procedure, the method of shaping PU three-dimensional objects could be further improved, the improved shape method including the following steps:

A. Install the mold in a proper location, open the evacuating valve in the shell, and connect the vacuum evacuating equipment with the evacuating valve of the shell;

B. Get out of the internal mold, and cover a ductile plastic film in the opening of the external mold;

C. Start the thermal element located in the upper end of the opening of the external mold

D. Start the vacuum evacuating equipment to extract the air between the installation gap of the shell and the external mold, to let the TPU film covered in the opening of the external mold extended and deformed and let the TPU film attach to the inner wall of the external mold;

E. Close the evacuating valve in the out wall of the shell, and stop the vacuum evacuating equipment;

F. Pour the PU raw materials;

G. Install the internal mold into the external mold and start the foaming process;

H. Release the mold.

In order to further improve the working procedure, the foresaid method of shaping PU three-dimensional objects could be further improved, the improved shape method including the following steps:

A. Install the mold in a proper location, open the evacuating valve in the shell, and connect the vacuum evacuating equipment with the evacuating valve of the shell;

B. Get out of the internal mold, and cover a ductile plastic film in the opening of the external mold;

C. Start the thermal element located in the upper end of the opening of the external mold

D. Start the vacuum evacuating equipment to extract the air between the installation gap of the shell and the external mold, to let the TPU film covered in the opening of the external mold extended and deformed and let the TPU film attach to the inner wall of the external mold;

E. Close the evacuating valve in the out wall of the shell, and stop the vacuum evacuating equipment;

F. Heating up the forming mold;

G. Pour the PU (hereinafter refers as Polyurethane) raw materials;

H. Install the internal mold into the external mold and start the foaming process;

I. Release the mold.

The forming method is effectively adopting the exothermic reaction of the PU foaming to print the pattern from the film layer completely and clearly.

The foresaid plastic film is TPU (hereinafter refers as Thermoplastic polyurethanes) film.

The foresaid TPU film has pattern layer and film layer.

For convenience to produce and protect the patter in the TPU film, the foresaid pattern layer and film layer are designed to be two separable layers, and after the foaming process completed, we could just strip away the film layer.

By comparison with the traditional shaping device and shaping method, the benefit of the invention is as following:

A. By applying the foresaid shaping device of the PU three-dimensional objects and its method composed thereof of the invention to produce the PU three-dimensional objects, the PU film has already attached to the inner wall of the external mold before the foam shaping process started, therefore after the foam shaping, the film will tightly attach to the surface of the PU products, so the shaped PU products are not need to get through the surface treatment processes such as polishing and filming.

B. When applying the foresaid shaping device of the PU three-dimensional objects and its method composed thereof of the invention, we could print the required color and pattern in the PU film in advanced, after the PU objects shaped, there is no need for the processes such as spraying and painting, and when the shapes of the objects remain unchanged, but the colors or patterns needed to be replaced, there is no need for replace the mold, we only need to change the PU film, which is simple, convenient and time-saving.

C. If the shell, the external mold and the internal mold is made by elastic materials, it could apply to the objects that have large cavity but small mouth; when releasing the mold, by pressing the mold to deform, then we could take the shaped objects; by comparison with the traditional split-type of mold, there are no traces of seaming in the surface, for which there is no need for further grinding and polishing, so that it saves labor time and enhance the working efficiency.

### DESCRIPTION OF FIGURES

FIG. 1 is the cutaway view of the Embodiment 1 of the invention;

FIG. 2 is the schematic diagram of the step B, step C and step D of the shaping method of the Embodiment 1;

FIG. 3 is the schematic diagram of the step E and step F of the shaping method of the Embodiment 1;

FIG. 4 is the schematic diagram of the step G of the shaping method of the Embodiment 1;

FIG. 5 is the cutaway view of the Embodiment 2 of the invention;

FIG. 6 is the front view of the external mold of the Embodiment 2;

FIG. 7 is the cutaway view of the shell of the Embodiment 2;

FIG. 8 is the cutaway view of the Embodiment 3 of the invention.

### List of Graphic Illustration:

Shell 1; External mold 2; internal mold 3; Thermal element 4; TPU film 5; Grooves 11 in warp direction; Grooves 12 in filling direction; Evacuating valve 13; Air slot 21 in warp direction; Air slot 22 in filing direction; Air vent 23.

### MODE OF CARRYING OUT THE INVENTION

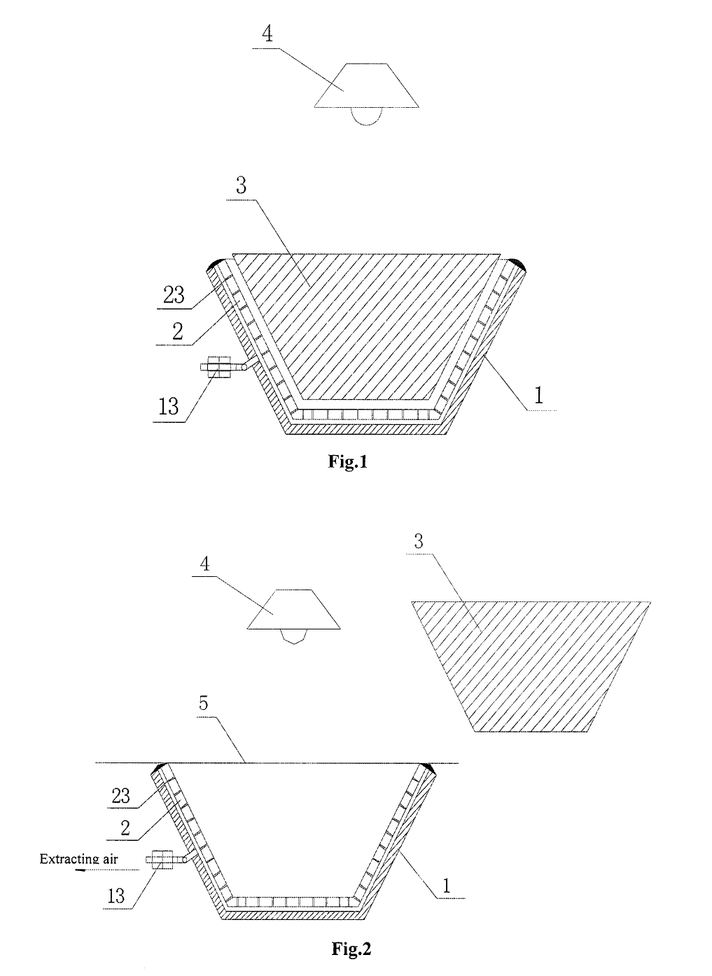

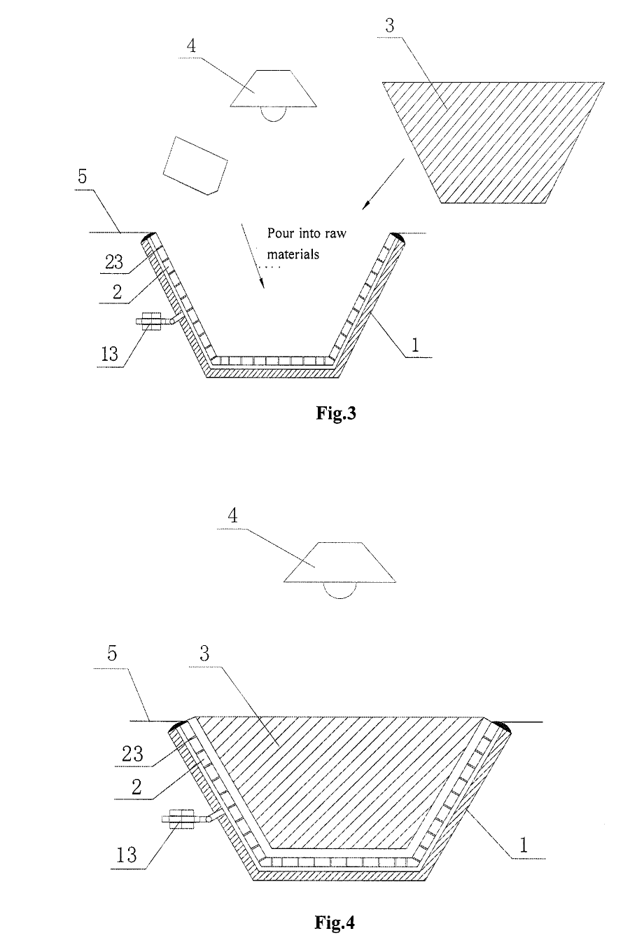

The Embodiment 1 as shown from FIG. 1 to FIG. 4, comprising by a shell 1, an external mold 2 with an opening, an internal mold 3 and an thermal element 4, wherein the outer wall of the shell 1 installs with an evacuating valve 13; the external mold 2 has air vent 23, and the size of the outer wall of the external mold 2 is smaller than the size of the inner wall of the shell 1; the external mold 2 installs insider the shell 1; the seams of the external mold 2 and the edge of the shell 1 is gas-tight sealed; the internal mold 3 installs insider the external mold; the thermal element 4 located in the upper end of the opening of the foresaid external mold 2.

A method of shaping PU three-dimensional objects including the following steps:

A. Install the mold in a proper location, open the evacuating valve 13 in the shell 1, and connect the vacuum evacuating equipment with the evacuating valve 13 of the shell 1;

B. Take out of the internal mold 3, and cover a ductile TPU plastic film 4 in the opening of the external mold;

C. Start the thermal element 4 located in the upper end of the opening of the external mold 2;

D. Start the vacuum evacuating equipment to extract the air between the installation gap of the shell 1 and the external mold 2, to let the TPU film covered in the opening of the external mold 2 extended and deformed and let the TPU film attach to the inner wall of the external mold 2;

E. Pour the PU raw materials into the mold;

F. install the internal mold into the external mold and start the foaming process;

G. Close the evacuating valve in the outer wall of the shell, and stop the vacuum evacuating equipment;

H. Release the mold.

The TPU film of the Embodiment 1 is the TPU film with pattern layer and film layer that are inseparable.

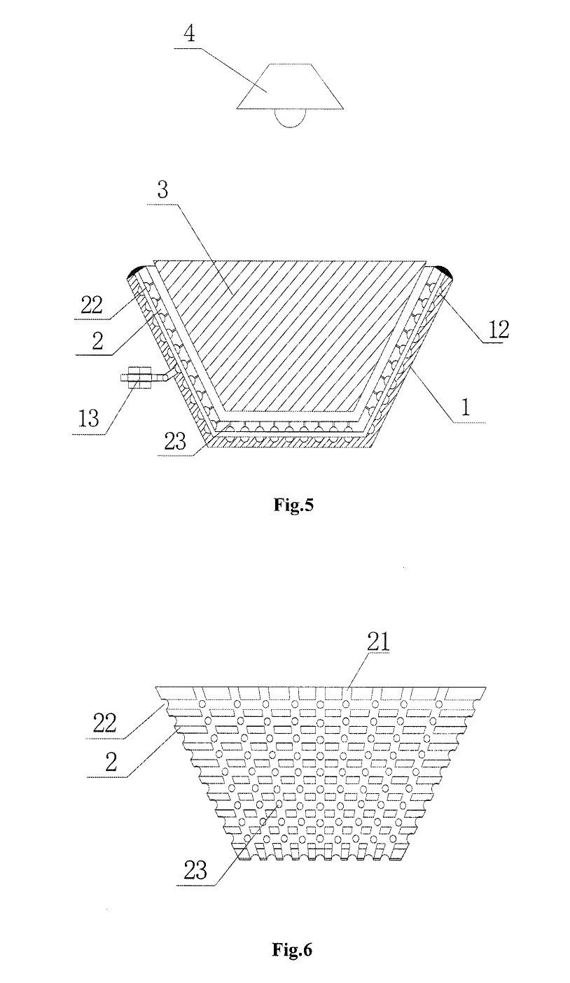

The Embodiment 2 as shown from FIG. 5 to FIG. 7, its difference from the Embodiment 1 is as: the inner wall of the shell 1 has several grooves 12 in filing direction that are perpendicular to the bottom face of the shell 1 and has grooves 11 in warp direction that are perpendicular to the grooves 12 in filing direction; the outer wall of the external mold 2 has air slot 22 in filing direction and air slot 21 in warp direction that are corresponding to the grooves 12 in filing direction and grooves 11 in warp direction of the inner wall of the external mold 2 in separately; the air vent 23 is located at the interlace place of the air slot 22 in filing direction and air slot 21 in warp direction. The design could let air between the outer wall of the external mold 2 and the inner wall of the shell I be drawn evenly, so that the film 4 is able to attach to the inner wall of the external mold evenly, to enhance the product quality.

The other difference of the Embodiment 2 and the Embodiment 1 is that the TPU film of the Embodiment 2 is the TPU film with pattern layer and film layer that are separable.

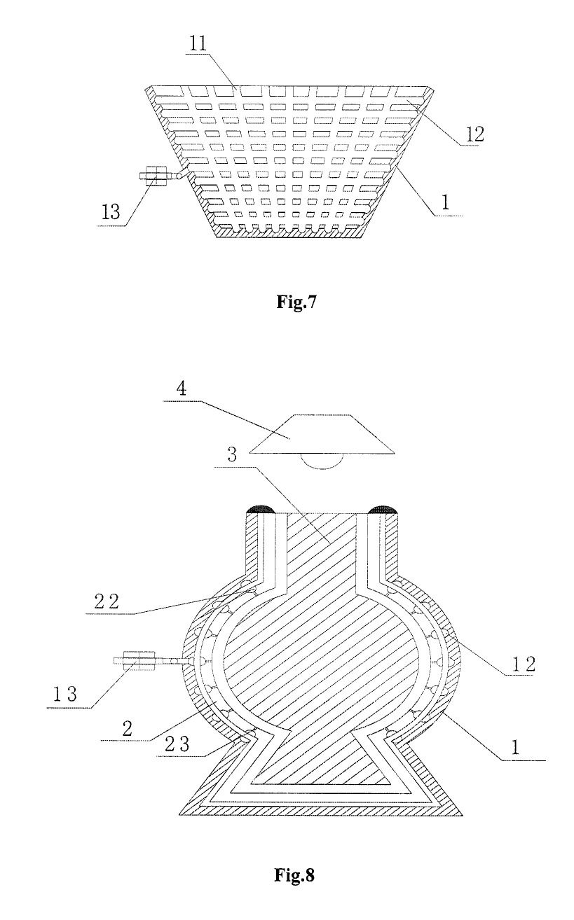

The Embodiment 3 as shown in FIG. 7, its difference from the Embodiment 1 and Embodiment 2 is as: the shape of the shell 1 and the external mold 2 is a shape of big mouth and small cavity, so the shell 1, external mold 2 and internal mold 3 of the Embodiment 3 are made by elastic materials for the convenience of releasing the mold after the foaming process.

The other difference of the Embodiment 3 from the Embodiment 1 and the Embodiment 2 is that the shaping method of the Embodiment 3 including the following steps:

A. Install the mold in a proper location, open the evacuating valve in the shell, and connect the vacuum evacuating equipment with the evacuating valve of the shell;

B. Take out of the internal mold, and cover a ductile plastic film in the opening of the external mold;

C. Start the thermal element located in the upper end of the opening of the external mold

D. Start the vacuum evacuating equipment to extract the air between the installation gap of the shell and the external mold, to let the TPU film covered in the opening of the external mold extended and deformed and let the TPU film attach to the inner wall of the external mold;

E. Close the evacuating valve in the out wall of the shell, and stop the vacuum evacuating equipment;

F. Heating up the forming mold;

G. Pour the PU raw materials into the mold;

H. Install the internal mold into the external mold and start the foaming process;

Release the mold.

Hereinto by heating the shaping mold before pouring into the PU raw materials into the mold, which is effectively adopting the exothermic reaction of the PU foaming to print the pattern from the film layer completely and clearly.

In the above three Embodiments, the TPU film (surface-filming for the finished products) could adopt different kinds according to different needs, we could use the TPU film that is single layer and colorless, or use the coated pattern and color as needed, but the TPU should be the TPU film with inseparable pattern layer and film layer; or use the coated pattern and color as needed, but the TPU should be the TPU film with separable pattern layer and film layer;

The above Embodiments are merely for better understand of the invention, is not the limitation for the invention, the general technicists of related fields, could make multiple changes or variations of the invention based on the technical proposal of the foresaid claims, such as the foresaid external mold of the invention could be made by the materials as ventilate ceramic, aluminum, steel and so on, the foresaid groove and air slot could be placed in the flank of the mold or in the bottom of the mold, meanwhile they could be lined obliquely, or if the PU film has good quality of cold ductility, there is no need to start the heating equipment, such changes and variations should be understood within the range of the protection of the invention.

What is claimed is:

1. A shaping device of PU (Polyurethane) three-dimensional objects, including an external mold with at least one opening and an internal mold, characterized in that the foresaid PU three-dimensional objects shaping device also includes a shell, wherein the outer wall of the foresaid shell installed with an evacuating valve; the foresaid external mold has air vent, and the size of the outer wall of the foresaid external mold is smaller than the size of the inner wall of the foresaid shell; the foresaid external mold installs insider the shell; the seams of the foresaid external mold and the edge of the shell is gas-tight sealed; the foresaid internal mold installs insider the foresaid external mold.

2. A shaping device of PU three-dimensional objects as set forth in claim 1, characterized in that the foresaid shell, external mold and internal mold are made by elastic materials.

3. A shaping device of PU three-dimensional objects as set forth in claim 2, characterized in that the foresaid inner wall of the shell has at least two grooves.

4. A shaping device of PU three-dimensional objects as set forth in claim 3, characterized in that the foresaid grooves of the inner wall of the shell interlaced with each other.

5. A shaping device of PU three-dimensional objects as set forth in claim 4, characterized in that the foresaid grooves of the inner wall of the shell has groove in warp direction that is perpendicular to the bottom face of the shell and has groove in filling direction that is parallel to the bottom face of the shell.

6. A shaping device of PU three-dimensional objects as set forth in claim 3, characterized in that the foresaid outer wall of the external mold has air slot that is corresponding to the groove of the inner wall of the shell.

7. A shaping device of PU three-dimensional objects as set forth in claim 6, characterized in that the air vent of the foresaid external mold is located at the foresaid air slot.

8. A shaping device of PU three-dimensional objects as set forth in claim 4, characterized in that the foresaid out wall of the external mold has air slot that is corresponding to the groove of the inner wall of the shell; and the air vent of the foresaid external mold is located at the foresaid air slot.

9. A shaping device of PU three-dimensional objects as set forth in claim 5, characterized in that the foresaid out wall of the external mold has air slot that is corresponding to the groove of the inner wall of the shell; and the air vent of the foresaid external mold is located at the foresaid air slot.

10. A shaping device of PU three-dimensional objects as set forth in claim 7, characterized in that the air vent of the foresaid external mold is located at the interlace place of the air slots.

11. A shaping device of PU three-dimensional objects as set forth in claim 1, characterized in that the foresaid shaping device of PU three-dimensional objects also includes thermal element, wherein the foresaid thermal element located in the upper end of the opening of the foresaid external mold.

12. A method of shaping PU three-dimensional objects, characterized in that the foresaid method of shaping PU three-dimensional objects including the following steps:
A. Install the mold in a proper location, open the evacuating valve in the shell, and connect the vacuum evacuating equipment with the evacuating valve of the shell;
B. Take out of the internal mold, and cover a ductile plastic film in the opening of the external mold;
C. Start the vacuum evacuating equipment to extract the air between the installation gap of the shell and the external mold, to let the Thermoplastic polyurethanes (TPU) film covered in the opening of the external mold extended and deformed and let the TPU film attach to the inner wall of the external mold;
D. Pour the Polyurethane (PU) raw materials;
E. Install the internal mold into the external mold and start the foaming process;
F. Close the evacuating valve in the outer wall of the shell, and stop the vacuum evacuating equipment;
G. Release the mold.

13. A method of shaping PU three-dimensional objects as set forth in claim 11, characterized in that the foresaid method of shaping PU three-dimensional objects including the following steps:
A. Install the mold in a proper location, open the evacuating valve in the shell, and connect the vacuum evacuating equipment with the evacuating valve of the shell;
B. Get out of the internal mold, and cover a ductile plastic film in the opening of the external mold;
C. Start the thermal element located in the upper end of the opening of the external mold
D. Start the vacuum evacuating equipment to extract the air between the installation gap of the shell and the external mold, to let the Thermoplastic polyurethanes (TPU) film covered in the opening of the external mold extended and deformed and let the Thermoplastic polyurethanes (TPU) film attach to the inner wall of the external mold;
E. Close the evacuating valve in the out wall of the shell, and stop the vacuum evacuating equipment;
F. Pour the Polyurethane (PU) raw materials;
G. Install the internal mold into the external mold and start the foaming process;
H. Release the mold.

14. A method of shaping PU three-dimensional objects as set forth in claim 12, characterized in that the foresaid method of shaping PU three-dimensional objects including the following steps:
A. Install the mold in a proper location, open the evacuating valve in the shell, and connect the vacuum evacuating equipment with the evacuating valve of the shell;
B. Get out of the internal mold, and cover a ductile plastic film in the opening of the external mold;
C. Start the thermal element located in the upper end of the opening of the external mold
D. Start the vacuum evacuating equipment to extract the air between the installation gap of the shell and the external mold, to let the Thermoplastic polyurethanes (TPU) film covered in the opening of the external mold extended and deformed and let the Thermoplastic polyurethanes (TPU) film attach to the inner wall of the external mold;
E. Close the evacuating valve in the out wall of the shell, and stop the vacuum evacuating equipment;
F. Heating up the shaping mold;
G. Pour the Polyurethane (PU) raw materials into the mold;
H. Install the internal mold into the external mold and start the foaming process;
I. Release the mold.

15. A method of shaping PU three-dimensional objects as set forth from claim 11 to claim 13, characterized in that the foresaid plastic film is Thermoplastic polyurethanes (TPU) film.

16. A method of shaping PU three-dimensional objects as set forth in claim 12, characterized in that the foresaid plastic film is Thermoplastic polyurethanes (TPU) film.

17. A method of shaping PU three-dimensional objects as set forth in claim 13, characterized in that the foresaid plastic film is Thermoplastic polyurethanes (TPU) film.

18. A method of shaping PU three-dimensional objects as set forth in claim 14, characterized in that the foresaid Thermoplastic polyurethanes (TPU) film has pattern layer and film layer.

19. A method of shaping PU three-dimensional objects as set forth in claim 15, characterized in that the foresaid pattern layer and film layer could be separated.
